(19) United States
(12) Patent Application Publication
(10) Pub. No.: US 2025/0085379 A1
(43) Pub. Date: Mar. 13, 2025

(54) SYSTEMS AND METHODS FOR GEOLOCATION OF USER EQUIPMENT

(71) Applicant: CommScope Technologies LLC, Claremont, NC (US)

(72) Inventor: Stuart D. Sandberg, Acton, MA (US)

(73) Assignee: CommScope Technologies LLC, Claremont, NC (US)

(21) Appl. No.: 18/727,539

(22) PCT Filed: Mar. 27, 2023
(86) PCT No.: PCT/US2023/016435

§ 371 Date: Jul. 9, 2024

(51) Int. Cl. G01S 5/02; G01S 5/14

(52) U.S. Cl. CPC G01S 5/02216; G01S 5/14

(57) ABSTRACT

Systems and methods for geolocation of user equipment are provided. In one example, a system includes BBU(s) and radio units communicatively coupled to the BBU(s). Each radio unit is configured to receive uplink signals from a user equipment. The system further includes antennas communicatively coupled to the radio units. Each respective radio unit is communicatively coupled to a respective subset of the antennas. The BBU(s), the radio units, and the antennas are configured to implement a base station for wirelessly communicating with user equipment. One or more components of the system are configured to determine, for each respective radio unit, a respective propagation delay for the uplink signals from the user equipment for the respective radio unit. The at least one BBU entity is configured to jointly process the respective propagation delays for each respective radio unit to determine an estimated position of the user equipment.

### CROSS-REFERENCE TO RELATED APPLICATIONS

This application claims priority to U.S. Provisional Application No. 63/325,263, filed on Mar. 30, 2022, and titled “SYSTEMS AND METHODS FOR GEOLOCATION OF USER EQUIPMENT,” the contents of which are incorporated herein by reference in their entirety.

### BACKGROUND

A centralized or cloud radio access network (C-RAN) is one way to implement base station functionality. Typically, for each cell (that is, for each physical cell identifier (PCI)) implemented by a C-RAN, one or more baseband unit (BBU) entities (also referred to herein simply as “BBUs”) interact with multiple radio units (also referred to here as “RUs,” “remote units,” “radio points,” or “RPs”) in order to provide wireless service to various items of user equipment (UEs). The one or more BBU entities may comprise a single entity (sometimes referred to as a “baseband controller” or simply a “baseband band unit” or “BBU”) that performs Layer-3, Layer-2, and some Layer-1 processing for the cell. The one or more BBU entities may also comprise multiple entities, for example, one or more central unit (CU) entities that implement Layer-3 and non-time critical Layer-2 functions for the associated base station and one or more distribution units (DU) that implement the time critical Layer-2 functions and at least some of the Layer-1 (also referred to as the Physical Layer) functions for the associated base station. Each CU can be further partitioned into one or more user-plane and control-plane entities that handle the user-plane and control-plane processing of the CU, respectively. Each such user-plane CU entity is also referred to as a “CU-UP,” and each such control-plane CU entity is also referred to as a “CU-CP.” In this example, each RU is configured to implement the radio frequency (RF) interface and the physical layer functions for the associated base station that are not implemented in the DU. The multiple radio units may be located remotely from each other (that is, the multiple radio units are not co-located) or collocated (for example, in instances where each radio unit processes different carriers or time slices), and the one or more BBU entities are communicatively coupled to the radio units over a fronthaul network.

For some applications, it is desirable to have the C-RAN provide an accurate position estimate for the location of a user equipment in communication with the C-RAN. For example, an accurate position estimate from the C-RAN could be beneficial for robotics applications at a factory or warehouse where an accurate position of the UE is needed to guide the UE through the environment. However, conventional Long-Term Evolution (LTE) or fifth generation (5G) New Radio (NR) base stations generally do not have this capability or do not provide a position estimate with the necessary accuracy.

### SUMMARY

In one aspect, a system includes at least one baseband unit (BBU) entity and a plurality of radio units communicatively coupled to the at least one BBU entity. Each radio unit of the plurality of radio units is configured to receive uplink signals from a user equipment. The system further includes a plurality of antennas communicatively coupled to the plurality of radio units. Each respective radio unit of the plurality of radio units is communicatively coupled to a respective subset of the plurality of antennas. The at least one BBU entity, the plurality of radio units, and the plurality of antennas are configured to implement a base station for wirelessly communicating with user equipment. One or more components of the system are configured to determine, for each respective radio unit of the plurality of radio units, a respective propagation delay for the uplink signals from the user equipment for the respective radio unit of the plurality of radio units. The at least one BBU entity is configured to jointly process the respective propagation delays for each respective radio unit of the plurality of radio units to determine an estimated position of the user equipment.

In another aspect, a method includes receiving, at a plurality of radio units, uplink signals from a user equipment. The plurality of radio units is communicatively coupled to at least one baseband unit (BBU) entity and a plurality of antennas. The at least one BBU entity, the plurality of radio units, and the plurality of antennas are configured to implement a base station for wirelessly communicating with user equipment. The method further includes determining, for each respective radio unit of the plurality of radio units, a respective propagation delay between the respective radio unit of the plurality of radio units and the user equipment. The method further includes jointly processing, at the at least one BBU entity, the respective propagation delays for each respective radio unit of the plurality of radio units to determine an estimated position of the user equipment.

### BRIEF DESCRIPTION OF THE DRAWINGS

Understanding that the drawings depict only exemplary embodiments and are not therefore to be considered limiting in scope, the exemplary embodiments will be described with additional specificity and detail through the use of the accompanying drawings, in which:

FIGS. 1A-1B are block diagrams illustrating example wireless systems in which the geolocation techniques described herein can be used;

FIG. 2 is a flow diagram illustrating an example method of geolocation of a user equipment;

FIG. 3 is a flow diagram illustrating an example method of determining a propagation delay estimate for uplink signals from a user equipment;

FIG. 4 is a diagram of an example impulse response at a radio point for various bandwidths and 0 dB scattering loss;

FIG. 5 is a plot of an example simulation result of a function used for the geolocation techniques described herein;

FIGS. 6A-6B are plots of example simulation tail probabilities of position estimate error for the geolocation techniques described herein based on scattering loss, clock error, and bandwidth; and

FIGS. 7A-7B are scatter plots of example simulations of position estimate error for the geolocation techniques described herein based on scattering loss and bandwidth.

In accordance with common practice, the various described features are not drawn to scale but are drawn to emphasize specific features relevant to the exemplary embodiments.

### DETAILED DESCRIPTION

In the following detailed description, reference is made to the accompanying drawings that form a part hereof, and in which is shown by way of illustration specific illustrative embodiments. However, it is to be understood that other embodiments may be used and that logical, mechanical, and electrical changes may be made. Furthermore, the method presented in the drawing figures and the specification is not to be construed as limiting the order in which the individual acts may be performed. The following detailed description is, therefore, not to be taken in a limiting sense.

One reason that conventional LTE or 5G NR base stations do not provide a position estimate with the necessary accuracy stems from a lack of sufficient coordination amongst RUs. Without sufficient coordination, joint processing techniques that include triangulation for determining the position estimate of the UE is not possible. The systems and methods described herein include determining a respective propagation delay for the uplink signals from the user equipment received at multiple RUs and jointly processing the propagation delays at the BBU entity, which enables a more accurate position estimate for the UE.

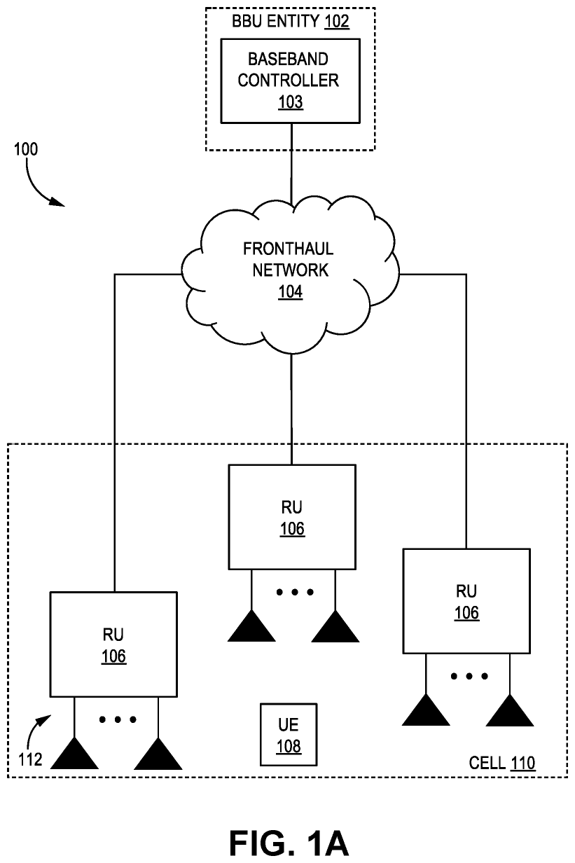

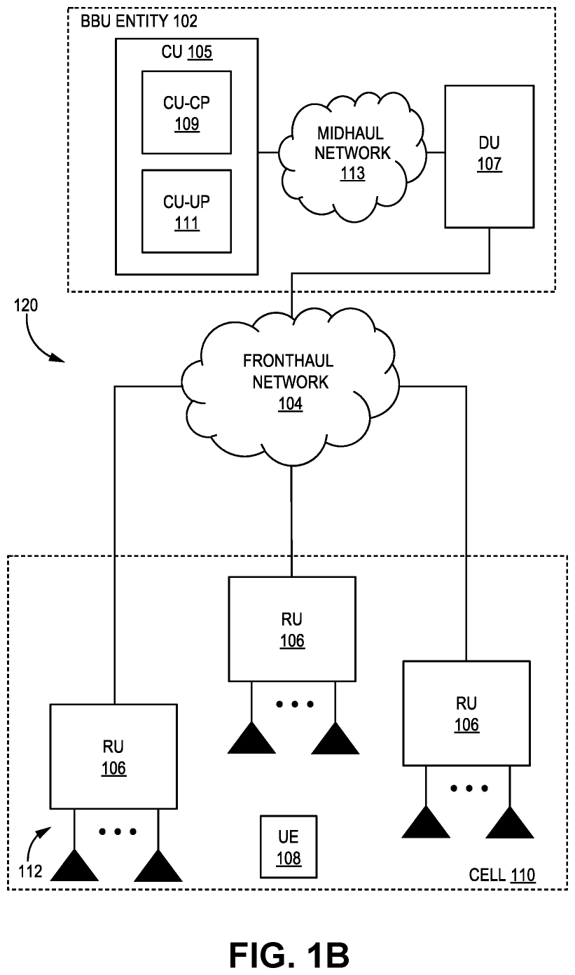

FIGS. 1A-1B illustrate block diagrams of example base stations 100, 120 in which the geolocation techniques described herein can be used. In the particular examples shown in FIGS. 1A-1B, the base stations 100, 120 includes one or more baseband unit (BBU) entities 102 communicatively coupled to multiple radio units RU 106 via a fronthaul network 104. The base stations 100, 120 provides wireless service to various UEs 108 in a cell 110. Each BBU entity 102 can also be referred to simply as a “BBU.”

In the example shown in FIG. 1A, the one or more BBU entities 102 comprise one or more baseband controllers 103. Each baseband controller 103 performs Layer-3, Layer-2, and some Layer-1 processing for the cell 110. The baseband controller 103 is communicatively coupled to multiple RUs 106 over a fronthaul network 104. In the example shown in FIG. 1A, the RUs 106 are configured to implement the radio frequency (RF) interface and the physical layer functions for the associated base station that are not implemented in the baseband controller 103. In some examples, the fronthaul network 104 is a switched Ethernet fronthaul network (for example, a switched Ethernet network that supports the Internet Protocol (IP)).

In the example shown in FIG. 1B, the one or more BBU entities 102 comprise one or more CUs 105 and one or more DUs 107. Each CU 105 implements Layer-3 and non-time critical Layer-2 functions for the cell 110. Each DU 107 is configured to implement the time critical Layer-2 functions and at least some of the Layer-1 (also referred to as the Physical Layer) functions for the cell 110. Each CU 105 can be further partitioned into one or more control-plane and user-plane entities 109, 111 that handle the control-plane and user-plane processing of the CU 105, respectively. Each such control-plane CU entity 109 is also referred to as a “CU-CP” 109, and each such user-plane CU entity 111 is also referred to as a “CU-UP” 111.

In the example shown in FIG. 1B, the RUs 106 are configured to implement the control-plane and user-plane Layer-1 functions not implemented by the DU 107 as well as the radio frequency (RF) functions. Each RU 106 is typically located remotely from the one or more BBU entities 102 and located remotely from other RUs 106. In the example shown in FIG. 1B, each RU 106 is implemented as a physical network function (PNF) and is deployed in or near a physical location where radio coverage is to be provided in the cell 110. In the example shown in FIG. 1B, the RUs 106 are communicatively coupled to the DU 107 using a fronthaul network 104. In some examples, the fronthaul network 104 is a switched Ethernet fronthaul network (for example, a switched Ethernet network that supports the Internet Protocol (IP)).

Each of the RUs 106 includes or is coupled to a respective set of antennas 112 via which downlink RF signals are radiated to UEs 108 and via which uplink RF signals transmitted by UEs 108 are received. In some examples, each set of antennas 112 includes two or four antennas. However, it should be understood that each set of antennas 112 can include one or more antennas 112. In one configuration (used, for example, in indoor deployments), each RU 106 is co-located with its respective set of antennas 112 and is remotely located from the one or more BBU entities 102 serving it and the other RUs 106. In another configuration (used, for example, in outdoor deployments), the sets of antennas 112 for the RUs 106 are deployed in a sectorized configuration (for example, mounted at the top of a tower or mast). In such a sectorized configuration, the RUs 106 need not be co-located with the respective sets of antennas 112 and, for example, can be located at the base of the tower or mast structure, for example, and, possibly, co-located with the serving one or more BBU entities 102. Other configurations can be used. In general, configurations with RUs 106 and antennas 112 distributed throughout the UE 108 environment provide better performance for the geolocation techniques described herein compared to configurations with collocated RUs 106 and/or collocated antennas 112.

The base stations 100, 120 that include the components shown in FIGS. 1A-1B can be implemented using a scalable cloud environment in which resources used to instantiate each type of entity can be scaled horizontally (that is, by increasing or decreasing the number of physical computers or other physical devices) and vertically (that is, by increasing or decreasing the “power” (for example, by increasing the amount of processing and/or memory resources) of a given physical computer or other physical device). The scalable cloud environment can be implemented in various ways. For example, the scalable cloud environment can be implemented using hardware virtualization, operating system virtualization, and application virtualization (also referred to as containerization) as well as various combinations of two or more of the preceding. The scalable cloud environment can be implemented in other ways. In some examples, the scalable cloud environment is implemented in a distributed manner. That is, the scalable cloud environment is implemented as a distributed scalable cloud environment comprising at least one central cloud, at least one edge cloud, and at least one radio cloud.

In some examples, one or more components of the one or more BBU entities 102 (for example, the CU 105, CU-CP 109, CU-UP 111, and/or DU 107) are implemented as a software virtualized entities that are executed in a scalable cloud environment on a cloud worker node under the control of the cloud native software executing on that cloud worker node. In some such examples, the DU 107 is communicatively coupled to at least one CU-CP 109 and at least one CU-UP 111, which can also be implemented as software virtualized entities. In some other examples, one or more components of the one or more BBU entities 102 (for example, the CU-CP 109, CU-UP 111, and/or DU 107) are implemented as a single virtualized entity executing on a single cloud worker node. In some examples, the at least one CU-CP 109 and the at least one CU-UP 111 can each be implemented as a single virtualized entity executing on the same cloud worker node or as a single virtualized entity executing on a different cloud worker node. However, it is to be understood that different configurations and examples can be implemented in other ways. For example, the CU 105 can be implemented using multiple CU-UP VNFs and using multiple virtualized entities executing on one or more cloud worker nodes. Moreover, it is to be understood that the CU 105 and DU 107 can be implemented in the same cloud (for example, together in a radio cloud or in an edge cloud). In some examples, the DU 107 is configured to be coupled to the CU-CP 109 and CU-UP 111 over a midhaul network 113 (for example, a network that supports the Internet Protocol (IP)). Other configurations and examples can be implemented in other ways.

As discussed above, there is a desire for base stations (such as base stations 100, 120) to provide accurate geolocation of UEs for certain applications. The base station 100, 120 is configured to estimate the position of a UE 108 based on uplink signals provided from the UE 108 to multiple RUs 106 in the cell 110 of the base station 100, 120. In general, the base station 100, 120 is configured to process uplink signals received at multiple RUs 106 and estimate a respective propagation delay for uplink signals from the UE 108 received at each respective RU 106. The base station 100, 120 is further configured to jointly process the estimated propagation delays for the respective RUs 106 to generate a position estimate for the UE 108.

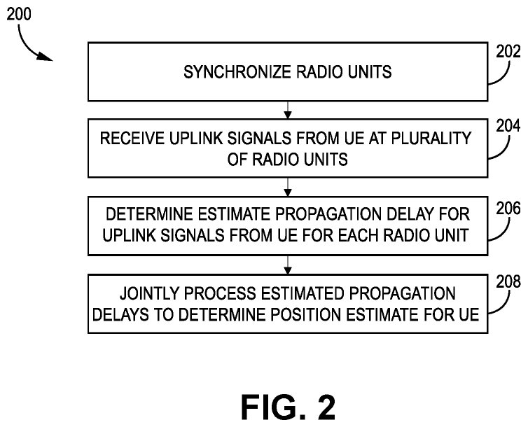

FIG. 2 is a flow diagram of an example method 200 of geolocation of a user equipment. The example method 200 shown in FIG. 2 is described herein as being implemented using the base stations 100, 120 shown in FIGS. 1A-1B. It is to be understood that other examples can be implemented in other ways.

The blocks of the flow diagram in FIG. 2 have been arranged in a generally sequential manner for ease of explanation; however, it is to be understood that this arrangement is merely exemplary, and it should be recognized that the processing associated with method 200 (and the blocks shown in FIG. 2) can occur in a different order (for example, where at least some of the processing associated with the blocks is performed in parallel in an event-driven manner).

The method 200 can be performed periodically when a location is needed for a UE. In some examples, the method 200 is performed whenever a particular type of uplink signal used to estimate the UE position is transmitted by the UE to the RUs of a base station.

The method 200 includes synchronizing a plurality of radio units (block 202). In some examples, the BBU entity is configured to synchronize the radio points (for example, act as timing master for the radio points) by exchanging synchronization messages with the radio points. In some such examples, the BBU entity is configured to use precise synchronization techniques (Precision Time Protocol (PTP) as described in the IEEE 1588 standard. For example, the BBU entity can exchange downlink synchronization packets and uplink synchronization delay requests with the radio points to enable the radio points to synchronize. In some such examples, the BBU entity and the radio points are configured to utilize a higher PTP packet exchange rate (for example, 256 packets per second) to improve synchronization. Further, in some examples, to improve synchronization, the radio points include higher quality on-board clocks. For example, an on-board oven-controlled crystal oscillator (OCXO) with reduced phase noise characteristics can be used.

In some examples, the BBU entity is communicatively coupled to the radio points via one or more switches in the fronthaul network. In some such examples, all of the radio points share at least one access switch that is coupled to the BBU entity (for example, baseband controller or DU). In order to improve the synchronization, in some examples, the based station includes higher quality switches in the fronthaul network between the radio points and the BBU entity. For example, the switches in the fronthaul network can be selected to include less jitter, which reduces timing error between radio points. In some examples, the switches in the fronthaul network include a 1588 transparency feature (measuring packet residence time on the switch and updating the associated field in the 1588 packet), which results in less jitter.

The method 200 further includes with receiving uplink signals from a UE at a plurality of radio units (block 204). In some examples, the uplink signals from the UE are a Sounding Reference Signal (SRS). The regularity and periodicity of the SRS transmission of a UE makes SRS useful for applications where the position of the UE needs to be updated constantly (for example, if the UE is moving). In other examples, the uplink signals from the UE are Physical Uplink Shared Channel (PUSCH) signals. If the UE is active in scheduling, the PUSCH signals could also occur regularly and periodically. However, the PUSCH signals will not be transmitted as regularly as SRS for all UEs.

In general, the greater the bandwidth of the uplink signals, the more accurate the position estimate can be since the accuracy of the processing in blocks 206 and 208 can be enhanced with wider bandwidth signals. In some examples, the bandwidth of the uplink signals is 400 MHz or greater. In some such examples, the frequency of the uplink signals is greater than 6 GHz as the channel size in these higher frequency bands allows for wider bandwidth signal transmission. In other examples, the bandwidth of the uplink signals is less than 400 MHz. In some such examples, the frequency of the uplink signals is less than 6 GHz as the channel size in these lower frequency bands does not usually allow for quite as wide of signal bandwidth due to greater usage.

While specific types of signals, bandwidths of signals, and frequencies of signals are discussed above for the uplink signals, it should be understood that other types of uplink signals could also be used to estimate the position of the UE depending on the periodicity and bandwidth of the signals and the desired performance and needs of the system. For example, if the UE is not moving, then a less frequently occurring uplink signal could be used. Also, if the error tolerance for the position estimate of the UE is higher, then a lower bandwidth signal can be used.

The method 200 proceeds with determining an estimated propagation delay for the uplink signals from the UE for each of the plurality of radio units (block 206). The estimated propagation delay for the uplink signals can be determined using one or more components of the base station.

In some examples, each radio unit is configured to determine an estimated propagation delay for the uplink signals it receives from the UE. In such examples, the radio points are configured to provide the estimated propagation delay to the BBU entity for joint processing. In some such examples, the radio units are configured to provide the propagation delay estimates to the BBU entity using out-of-band signaling over the fronthaul network (for example, a side field or side channel of the fronthaul network).

In other examples, the BBU entity is configured to determine the estimated propagation delays for all of the radio units. In such examples, the radio units are configured to provide information regarding the uplink signals to the BBU entity for determining the estimated propagation delays. In some such examples, the radio units are configured to provide the uplink signals (or the physical resource blocks (PRBs) associated with the uplink signals) to the BBU entity. This information can generally be provided using in-band signaling over the fronthaul network (for example, PRBs associated with SRS or PUSCH signals).

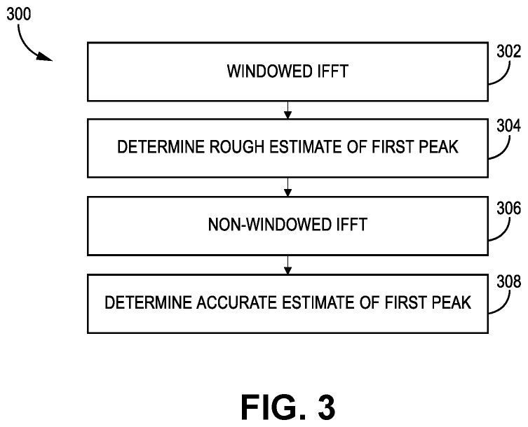

Some example techniques for determining the estimated propagation delay for the uplink signals include detection of the first peak (line-of-sight peak) in the impulse response for the uplink signal. Some examples peak detection techniques are discussed herein with respect to FIG. 3.

FIG. 3 is a flow diagram illustrating an example method 300 of determining a propagation delay for uplink signals from a user equipment. The example method 300 shown in FIG. 3 is described herein as being implemented using the base stations 100, 120 shown in FIGS. 1A-1B. In some examples, the method 300 is utilized to determine the propagation delay estimate for each radio point.

The blocks of the flow diagram in FIG. 3 have been arranged in a generally sequential manner for ease of explanation; however, it is to be understood that this arrangement is merely exemplary, and it should be recognized that the processing associated with method 300 (and the blocks shown in FIG. 3) can occur in a different order (for example, where at least some of the processing associated with the blocks is performed in parallel in an event-driven manner).

The method 300 includes performing a windowed inverse fast Fourier transform (IFFT) to generate a windowed, time-domain impulse response from the received uplink signals from the UE (block 302). The window is applied to the samples of the uplink signals prior to the IFFT. In some examples, a Blackman-Harris window is used. It should be understood that other window functions could also be used.

The method 300 proceeds with determining a rough time estimate of the first peak in the windowed, time-domain impulse response (block 304). In some examples, determining a rough estimate of the first peak in the windowed, time-domain impulse response includes searching the windowed, time-domain impulse response starting from the time 0 sample until a sample with a magnitude above a threshold is found. In some examples, the threshold is selected to be within X dB of the peak magnitude of the windowed, time-domain impulse response. The threshold can be selected based on a number of factors including, but not limited to, environmental conditions, scattering conditions, bandwidth of the uplink signals, and/or desired accuracy of the geolocation.

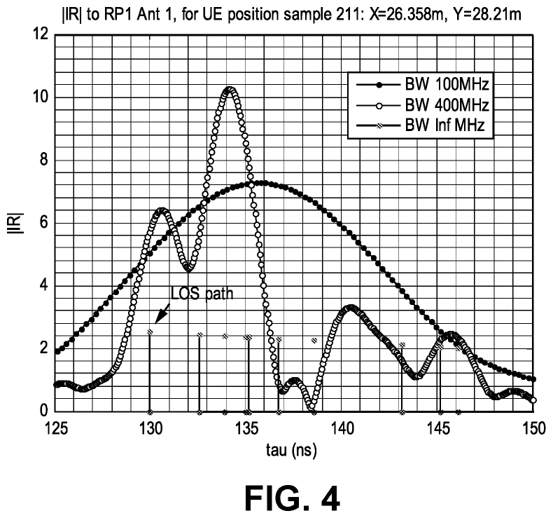

The method further includes performing a non-windowed IFFT to generate a non-windowed, time-domain impulse response from the uplink signals received from the user equipment (block 306). The non-windowed, time-domain impulse response generally includes better resolution (for example, sharper peaks) than the windowed, time-domain impulse response. FIG. 4 illustrates an example non-windowed, time-domain impulse response for signals having different bandwidths (100 MHz, 400 MHZ, and Infinite). If infinite bandwidth could be used for the uplink signals, then each distinct communication path for the uplink signal (line-of-sight and multipath) can be detected as a separate peak. However, as the bandwidth of the uplink signals decreases, the peaks for distinct communication paths get pulled together, which can affect the accuracy of the time estimate for propagation delay. As can be seen in FIG. 4, there are multiple peaks in the impulse response for 400 MHZ, and there is a single peak in the impulse response for 100 MHz.

The method further includes determining an accurate time estimate of a first peak in the non-windowed, time-domain impulse response (block 308). In some examples, determining an accurate estimate of a first peak in the non-windowed, time-domain impulse response includes searching the non-windowed, time-domain impulse response for a slope change (for example, from positive to negative). In some examples, searching of the non-windowed, time-domain impulse response starts at the time corresponding to the rough time estimate of the windowed, time-domain impulse response, which can improve accuracy of identifying the first peak without reusing the threshold. In the example shown in FIG. 4, the time estimate for the propagation delay corresponds to the point of the first peak shown where a sign of the slope of the non-windowed, time-domain impulse response turns from positive to negative.

It should be understood that alternative techniques for determining the propagation delay estimates can also be used in addition to, or instead of, the techniques described with respect to FIG. 3. For example, other algorithms such as the Multiple Signal Classification (MUSIC) algorithm could also be used. It should be understood that different techniques for determining the propagation delay can also be used.

Returning to FIG. 2, the method 200 further includes jointly processing the estimated propagation delays for each of the plurality of radio units to determine a position estimate for the UE (block 208). The BBU entity is configured to perform the joint processing of the estimated propagation delays based on known positions of the radio points. In some examples, the BBU entity is configured to utilize a likelihood function or a log likelihood function to jointly process the estimated propagation delays to generate the position estimate for the UE. For this technique, there is a grid of hypothesized positions of the UE and the estimated position of the UE selected is the maximum of the likelihood function or the log likelihood function.

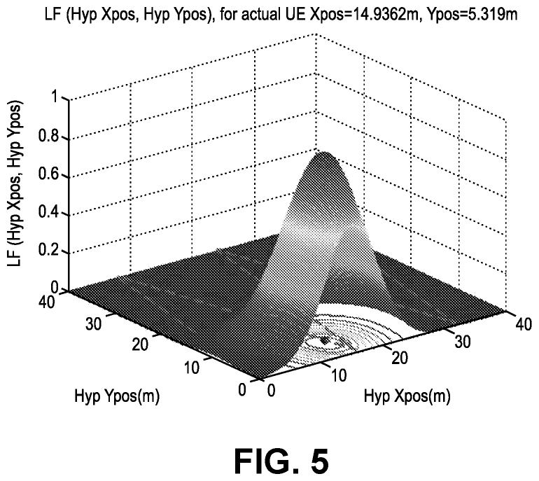

FIG. 5 illustrates an example likelihood function for the reception given a hypothesized UE position where five estimated propagation delays for radio points are utilized. The likelihood function at a given hypothesized position is a scaled product of the corresponding five individual conditional probability functions for the propagation delays, given the hypothesized UE position. As can be seen in FIG. 5, there is a clear maximum in the likelihood function, and the position corresponding to this maximum is selected as the estimated position of the UE.

In some examples, each radio unit is coupled to multiple antennas, which each receive uplink signals from the UE. The techniques described above are used to estimate the propagation delay for uplink signals received at each antenna. In some examples, each respective propagation delay for each respective antenna is used for determining the position estimate of the UE (for example, as a separate input for the likelihood function or log likelihood function). In other examples, the propagation delays for each antenna coupled to the same radio unit are combined (for example, averaged). In other examples, a subset of the propagation delays for the antennas coupled to the same radio unit are eliminated as outliers and the remaining propagation delays for the antennas coupled to the same radio unit combined (for example, averaged). For example, if there are four antennas coupled to a radio unit, then the propagation delay for two of the antennas can be eliminated and the propagation delay for the remaining two antennas can be averaged to generate a single combined propagation delay estimate for the radio unit.

In some examples, the position estimate(s) for the UE from the past can be used to improve performance. In some such examples, the position estimate(s) for the UE from the past can be used to determine whether the current position estimate of the UE is acceptable by comparing the current position estimate of the UE to a linear fit of previous position estimates of the UE determined for earlier points in time. In some such examples, a difference between the current position estimate of the UE and a linear fit of previous position estimates of the UE is compared to a threshold. The threshold can correspond to a tolerable amount of position error, which can depend on environmental conditions, scattering conditions, bandwidth of the uplink signals, and/or desired accuracy of the geolocation. In other examples, the position estimate(s) for the UE from the past can be combined with the current position estimate (for example, using exponential averaging or other techniques that phase out older measurements over time).

In some examples, the system will have access to known information regarding a path that the UE is expected to travel. For example, the system may be controlling the UE's movement as part of the geolocation or the UE's movement may be limited to known, designated paths (for example, in a factory or warehouse environment). In such examples, the BBU entity can use the known information regarding the path of the UE to reduce the number of hypothesized positions for the UE in the likelihood function or log likelihood function or combine the known information with the propagation delay estimates to smooth or denoise the position estimate for the UE.

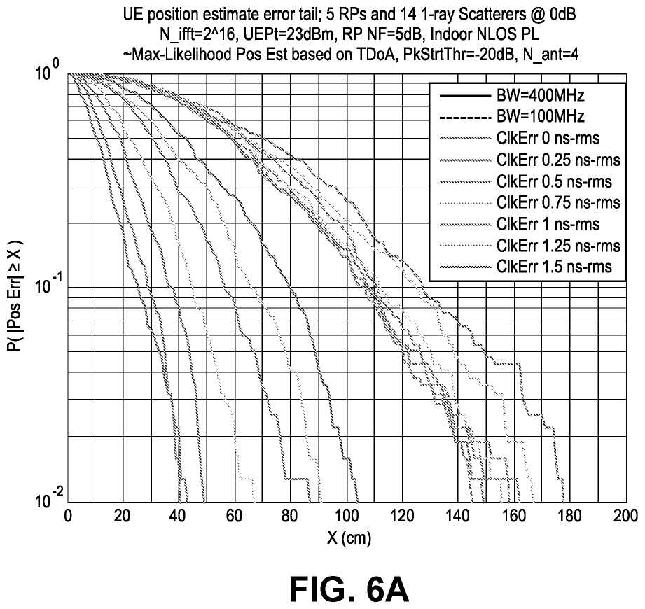

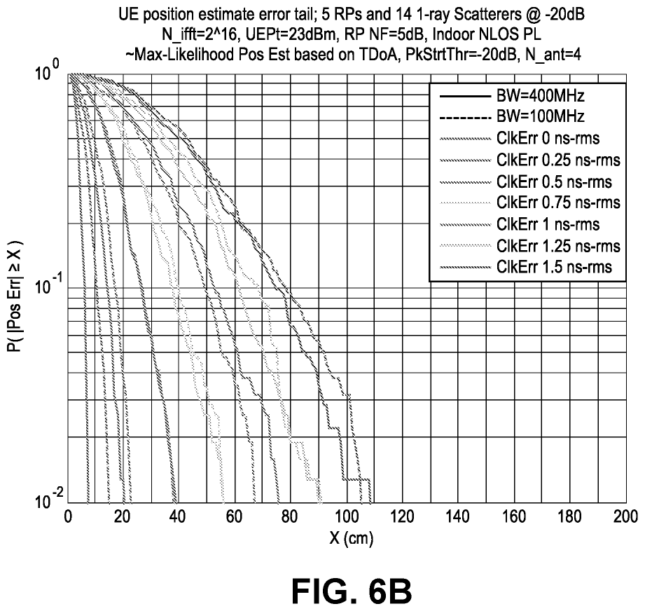

By utilizing the techniques described above, an estimate position for a UE can be determined that is accurate enough for many applications, which has been shown with simulations. FIGS. 6A-6B show tail probabilities of positioning error for a particular simulation with five radio units and particular conditions. The solid lines illustrate the tail probabilities for a 400 MHz bandwidth uplink signal and each different line corresponds to a different level of clock error. The dashed lines illustrate the tail probabilities for a 100 MHz bandwidth uplink signal and each different line corresponds to a different level of clock error. In the example shown in FIG. 6A, it is assumed that there is 0 dB scattering loss. In the example shown in FIG. 6B, it is assumed that there is a 20 dB scattering loss. As can be seen in FIGS. 6A and 6B, the performance of the techniques discussed above improves when there is higher loss off of scattering elements. This is particularly the case for 100 MHz bandwidth uplink signals, which lead to comparable accuracy compared to the 400 MHz bandwidth uplink signals when there is higher scattering loss.

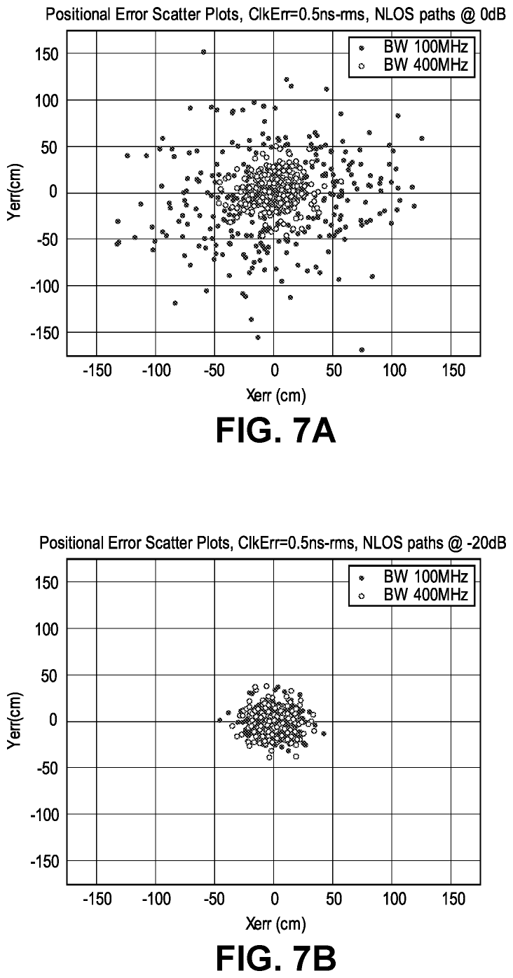

FIGS. 7A-7B illustrate position error scatter plots for a particular simulation with five radio units and particular conditions. The blue dots illustrate the position error for a 400 MHz bandwidth uplink signal and the red dots illustrate the position error for a 100 MHz bandwidth uplink signal. In the example shown in FIG. 7A, it is assumed that there is 0 dB scattering loss. In the example shown in FIG. 7B, it is assumed that there is a 20 dB scattering loss. As can be seen in FIGS. 7A and 7B, the performance of the techniques discussed above improves when there is higher loss off of scattering elements. This is particularly the case for 100 MHz bandwidth uplink signals, which lead to comparable accuracy compared to the 400 MHz bandwidth uplink signals when there is higher scattering loss.

The methods and techniques described here may be implemented in digital electronic circuitry, or with a programmable processor (for example, a special-purpose processor or a general-purpose processor such as a computer) firmware, software, or in combinations of them. Apparatus embodying these techniques may include appropriate input and output devices, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system including at least one programmable processor coupled to receive data and instructions from, and to transmit data and instructions to, a data storage system, at least one input device, and at least one output device. Generally, a processor will receive instructions and data from a read-only memory and/or a random-access memory. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and DVD disks. Any of the foregoing may be supplemented by, or incorporated in, specially-designed application-specific integrated circuits (ASICs).

### Example Embodiments

Example 1 includes a system, comprising: at least one baseband unit (BBU) entity; a plurality of radio units communicatively coupled to the at least one BBU entity, wherein each radio unit of the plurality of radio units is configured to receive uplink signals from a user equipment; a plurality of antennas communicatively coupled to the plurality of radio units, wherein each respective radio unit of the plurality of radio units is communicatively coupled to a respective subset of the plurality of antennas; wherein the at least one BBU entity, the plurality of radio units, and the plurality of antennas are configured to implement a base station for wirelessly communicating with user equipment; wherein one or more components of the system are configured to determine, for each respective radio unit of the plurality of radio units, a respective propagation delay for the uplink signals from the user equipment for the respective radio unit of the plurality of radio units; wherein the at least one BBU entity is configured to jointly process the respective propagation delays for each respective radio unit of the plurality of radio units to determine an estimated position of the user equipment.

Example 2 includes the system of Example 1, wherein the one or more components of the system include the at least one BBU entity, wherein the at least one BBU entity is configured to receive information regarding the uplink signals from the plurality of radio units, wherein the at least one BBU entity is configured to determine, for each respective radio unit of the plurality of radio units, the respective propagation delay for the uplink signals from the user equipment for the respective radio unit of the plurality of radio units.

Example 3 includes the system of any of Examples 1-2, wherein the one or more components of the system include the plurality of radio units, wherein each respective radio unit of the plurality of radio units is configured to determine the respective propagation delay for the uplink signals from the user equipment for the respective radio unit of the plurality of radio units.

Example 4 includes the system of any of Examples 1-3, wherein the one or more components of the system are configured to determine, for each respective radio unit of the plurality of radio units, the respective propagation delay for the uplink signals from the user equipment for the respective radio unit of the plurality of radio units by: performing a windowed inverse fast Fourier transform (IFFT) to generate a first time-domain impulse response from the uplink signals from the user equipment received at the respective radio unit; determining an estimate of a general location of a peak in the first time-domain impulse response, wherein based on when a first sample of the first time-domain impulse response exceeds a threshold; performing a non-windowed IFFT to generate a second time-domain impulse response from the uplink signals from the user equipment received at the respective radio unit; and determine an estimate of a precise location of a first peak in the second time-domain impulse response based on the estimate of the general location of the peak in the first time-domain impulse response, wherein the precise location of the peak in the second time-domain impulse response is determined to be at a time where a sign of a slope of the second time-domain impulse response changes from positive to negative.

Example 5 includes the system of any of Examples 1-4, wherein the at least one BBU entity is configured to jointly process the respective propagation delays for each respective radio unit of the plurality of radio units to determine the estimated position of the user equipment using a likelihood function or a log likelihood function.

Example 6 includes the system of any of Examples 1-5, wherein the system is configured to synchronize operation of the plurality of radio units.

Example 7 includes the system of any of Examples 1-6, wherein the uplink signals from the user equipment comprise a sounding reference signal (SRS) and/or physical uplink shared channel (PUSCH) signals.

Example 8 includes the system of any of Examples 1-7, wherein a bandwidth of the uplink signals from the user equipment is 400 MHz or greater.

Example 9 includes the system of any of Examples 1-8, wherein the at least one BBU entity is configured to jointly process the respective propagation delays for each respective radio unit of the plurality of radio units to determine the estimated position of the user equipment by using previous position estimates of the user equipment determined for earlier points in time.

Example 10 includes the system of any of Examples 1-9, wherein the at least one BBU entity is configured to determine whether the estimated position of the user equipment is acceptable by comparing the estimated position of the user equipment to a linear fit of previous position estimates of the user equipment determined for earlier points in time.

Example 11 includes the system of any of Examples 1-10, wherein the at least one BBU entity is configured to jointly process the respective propagation delays for each respective radio unit of the plurality of radio units to determine the estimated position of the user equipment by using known information about a path of the user equipment.

Example 12 includes the system of any of Examples 1-11, wherein a first radio unit of the plurality of radio units includes or is coupled to two or more antennas, wherein the one or more components of the system are configured to determine a respective propagation delay for the uplink signals from the user equipment for each antenna of the two or more antennas.

Example 13 includes a method, comprising: receiving, at a plurality of radio units, uplink signals from a user equipment, wherein the plurality of radio units is communicatively coupled to at least one baseband unit (BBU) entity and a plurality of antennas, wherein the at least one BBU entity, the plurality of radio units, and the plurality of antennas are configured to implement a base station for wirelessly communicating with user equipment; determining, for each respective radio unit of the plurality of radio units, a respective propagation delay between the respective radio unit of the plurality of radio units and the user equipment; and jointly processing, at the at least one BBU entity communicatively coupled to the plurality of radio units, the respective propagation delays for each respective radio unit of the plurality of radio units to determine an estimated position of the user equipment.

Example 14 includes the method of Example 13, wherein determining, for each respective radio unit of the plurality of radio units, the respective propagation delay for the uplink signals from the user equipment for the respective radio unit of the plurality of radio units includes: performing a windowed inverse fast Fourier transform (IFFT) to generate a first time-domain impulse response from the uplink signals from the user equipment received at the respective radio unit; determining an estimate of a general location of a peak in the first time-domain impulse response, wherein based on when a first sample of the first time-domain impulse response exceeds a threshold; performing a non-windowed IFFT to generate a second time-domain impulse response from the uplink signals from the user equipment received at the respective radio unit; and determine an estimate of a precise location of a first peak in the second time-domain impulse response based on the estimate of the general location of the peak in the first time-domain impulse response, wherein the precise location of the peak in the second time-domain impulse response is determined to be at a time where a sign of a slope of the second time-domain impulse response changes from positive to negative.

Example 15 includes the method of any of Examples 13-14, jointly processing, at the at least one BBU entity, the respective propagation delays for each respective radio unit of the plurality of radio units to determine the estimated position of the user equipment includes using a likelihood function or a log likelihood function.

Example 16 includes the method of any of Examples 13-15, wherein the method further comprising synchronizing operation of the plurality of radio units.

Example 17 includes the method of any of Examples 13-16, wherein the uplink signals from the user equipment comprise a sounding reference signal (SRS) and/or physical uplink shared channel (PUSCH) signals.

Example 18 includes the method of any of Examples 13-17, wherein a bandwidth of the uplink signals from the user equipment is 400 MHz or greater.

Example 19 includes the method of any of Examples 13-18, wherein the method further comprises determining whether the estimated position of the user equipment is acceptable by comparing the estimated position of the user equipment to a linear fit of previous position estimates of the user equipment determined for earlier points in time.

Example 20 includes the method of any of Examples 13-19, wherein jointly processing the respective propagation delays for each respective radio unit of the plurality of radio units to determine the estimated position estimate of the user equipment includes using known information about a path of the user equipment.

A number of embodiments of the invention defined by the following claims have been described. Nevertheless, it will be understood that various modifications to the described embodiments may be made without departing from the spirit and scope of the claimed invention. Accordingly, other embodiments are within the scope of the following claims.

What is claimed is:

1. A system, comprising:
at least one baseband unit (BBU) entity;
a plurality of radio units communicatively coupled to the at least one BBU entity, wherein each radio unit of the plurality of radio units is configured to receive uplink signals from a user equipment;
a plurality of antennas communicatively coupled to the plurality of radio units, wherein each respective radio unit of the plurality of radio units is communicatively coupled to a respective subset of the plurality of antennas;
wherein the at least one BBU entity, the plurality of radio units, and the plurality of antennas are configured to implement a base station for wirelessly communicating with user equipment;
wherein one or more components of the system are configured to determine, for each respective radio unit of the plurality of radio units, a respective propagation delay for the uplink signals from the user equipment for the respective radio unit of the plurality of radio units;
wherein the at least one BBU entity is configured to jointly process the respective propagation delays for each respective radio unit of the plurality of radio units to determine an estimated position of the user equipment.

2. The system of claim 1, wherein the one or more components of the system include the at least one BBU entity, wherein the at least one BBU entity is configured to receive information regarding the uplink signals from the plurality of radio units, wherein the at least one BBU entity is configured to determine, for each respective radio unit of the plurality of radio units, the respective propagation delay for the uplink signals from the user equipment for the respective radio unit of the plurality of radio units.

3. The system of claim 1, wherein the one or more components of the system include the plurality of radio units, wherein each respective radio unit of the plurality of radio units is configured to determine the respective propagation delay for the uplink signals from the user equipment for the respective radio unit of the plurality of radio units.

4. The system of claim 1, wherein the one or more components of the system are configured to determine, for each respective radio unit of the plurality of radio units, the respective propagation delay for the uplink signals from the user equipment for the respective radio unit of the plurality of radio units by:
performing a windowed inverse fast Fourier transform (IFFT) to generate a first time-domain impulse response from the uplink signals from the user equipment received at the respective radio unit;
determining an estimate of a general location of a peak in the first time-domain impulse response, wherein based on when a first sample of the first time-domain impulse response exceeds a threshold;
performing a non-windowed IFFT to generate a second time-domain impulse response from the uplink signals from the user equipment received at the respective radio unit; and
determine an estimate of a precise location of a first peak in the second time-domain impulse response based on the estimate of the general location of the peak in the first time-domain impulse response, wherein the precise location of the peak in the second time-domain impulse response is determined to be at a time where a sign of a slope of the second time-domain impulse response changes from positive to negative.

5. The system of claim 1, wherein the at least one BBU entity is configured to jointly process the respective propagation delays for each respective radio unit of the plurality of radio units to determine the estimated position of the user equipment using a likelihood function or a log likelihood function.

6. The system of claim 1, wherein the system is configured to synchronize operation of the plurality of radio units.

7. The system of claim 1, wherein the uplink signals from the user equipment comprise a sounding reference signal (SRS) and/or physical uplink shared channel (PUSCH) signals.

8. The system of claim 1, wherein a bandwidth of the uplink signals from the user equipment is 400 MHz or greater.

9. The system of claim 1, wherein the at least one BBU entity is configured to jointly process the respective propagation delays for each respective radio unit of the plurality of radio units to determine the estimated position of the user equipment by using previous position estimates of the user equipment determined for earlier points in time.

10. The system of claim 1, wherein the at least one BBU entity is configured to determine whether the estimated position of the user equipment is acceptable by comparing the estimated position of the user equipment to a linear fit of previous position estimates of the user equipment determined for earlier points in time.

11. The system of claim 1, wherein the at least one BBU entity is configured to jointly process the respective propagation delays for each respective radio unit of the plurality of radio units to determine the estimated position of the user equipment by using known information about a path of the user equipment.

12. The system of claim 1, wherein a first radio unit of the plurality of radio units includes or is coupled to two or more antennas, wherein the one or more components of the system are configured to determine a respective propagation delay for the uplink signals from the user equipment for each antenna of the two or more antennas.

13. A method, comprising:
receiving, at a plurality of radio units, uplink signals from a user equipment, wherein the plurality of radio units is communicatively coupled to at least one baseband unit (BBU) entity and a plurality of antennas, wherein the at least one BBU entity, the plurality of radio units, and the plurality of antennas are configured to implement a base station for wirelessly communicating with user equipment;
determining, for each respective radio unit of the plurality of radio units, a respective propagation delay between the respective radio unit of the plurality of radio units and the user equipment; and
jointly processing, at the at least one BBU entity, the respective propagation delays for each respective radio unit of the plurality of radio units to determine an estimated position of the user equipment.

14. The method of claim 13, wherein determining, for each respective radio unit of the plurality of radio units, the respective propagation delay for the uplink signals from the user equipment for the respective radio unit of the plurality of radio units includes:
performing a windowed inverse fast Fourier transform (IFFT) to generate a first time-domain impulse response from the uplink signals from the user equipment received at the respective radio unit;
determining an estimate of a general location of a peak in the first time-domain impulse response, wherein based on when a first sample of the first time-domain impulse response exceeds a threshold;
performing a non-windowed IFFT to generate a second time-domain impulse response from the uplink signals from the user equipment received at the respective radio unit; and
determine an estimate of a precise location of a first peak in the second time-domain impulse response based on the estimate of the general location of the peak in the first time-domain impulse response, wherein the precise location of the peak in the second time-domain impulse response is determined to be at a time where a sign of a slope of the second time-domain impulse response changes from positive to negative.

15. The method of claim 13, jointly processing, at the at least one BBU entity communicatively coupled to the plurality of radio units, the respective propagation delays for each respective radio unit of the plurality of radio units to determine the estimated position of the user equipment includes using a likelihood function or a log likelihood function.

16. The method of claim 13, wherein the method further comprising synchronizing operation of the plurality of radio units.

17. The method of claim 13, wherein the uplink signals from the user equipment comprise a sounding reference signal (SRS) and/or physical uplink shared channel (PUSCH) signals.

18. The method of claim 13, wherein a bandwidth of the uplink signals from the user equipment is 400 MHz or greater.

19. The method of claim 13, wherein the method further comprises determining whether the estimated position of the user equipment is acceptable by comparing the estimated position of the user equipment to a linear fit of previous position estimates of the user equipment determined for earlier points in time.

20. The method of claim 13, wherein jointly processing the respective propagation delays for each respective radio unit of the plurality of radio units to determine the estimated position estimate of the user equipment includes using known information about a path of the user equipment.
